(19) United States
(12) Patent Application Publication
(10) Pub. No.: US 2010/0145750 A1
(43) Pub. Date: Jun. 10, 2010

(54) Evaluating Service Oriented Architecture Governance Maturity

(75) Inventors: Anthony L. Carrato, New Milford, CT (US); Sieds Eitens, Zeegse (NL); John A. Falkl, Brewster, NY (US); Robert G. Laird, Colorado Springs, CO (US)

Correspondence Address: BIGGERS & OHANIAN (END), C/O BIGGERS & OHANIAN, LLP, P.O. BOX 1469, AUSTIN, TX, 78767-1469, US

(73) Assignee: INTERNATIONAL BUSINESS MACHINES CORPORATION, Armonk, NY (US)

(21) Appl. No.: 12/330,821

(22) Filed: Dec. 9, 2008

(51) Int. Cl. G06Q 10/00

(52) U.S. Cl. 705/7

(57) ABSTRACT

Evaluating service oriented architecture (‘SOA’) governance maturity including receiving, from a plurality of predetermined stakeholders in the SOA for a plurality of SOA governance capabilities, a stakeholder assessed value representing the current maturity of each of the plurality of SOA governance capabilities; determining, for each of the plurality of SOA governance capabilities in dependence upon the plurality of stakeholder assessed values from the stakeholders, a capability value for each of the plurality of SOA governance capabilities; assigning each of the SOA governance capabilities to a domain; determining, in dependence upon the capability values for each of the plurality of SOA governance capabilities of each domain, a domain maturity value for each domain; and communicating the domain maturity value for each domain to the predetermined stakeholders of the SOA.

### BACKGROUND OF THE INVENTION

1. Field of the Invention

The field of the invention is data processing, or, more specifically, methods, systems, and products for evaluating service oriented architecture (‘SOA’) governance maturity.

2. Description Of Related Art

Service Oriented Architecture (‘SOA’) is an architectural style that guides all aspects of creating and using business processes, packaged as services, throughout their lifecycle, as well as defining and provisioning the IT (‘information technology’) infrastructure that allows different applications to exchange data and participate in business processes loosely coupled from the operating systems and programming languages underlying those applications. SOA represents a model in which functionality is decomposed into distinct units (services), which can be distributed over a network and can be combined together and reused to create business applications. These services communicate with each other by passing data from one service to another, or by coordinating an activity between two or more services. The concepts of Service Oriented Architecture are often seen as built upon, and the evolution of, the older concepts of distributed computing and modular programming.

Although services and a business's SOA architecture are often strictly defined, governance of an SOA, implementation of an SOA, operation of an SOA, and management of an SOA is often not defined. A defined model of governance, however, may increase effectiveness and efficiency in implementing, operating, and managing a business's SOA, thereby providing savings to the business. The maturity of that SOA governance may vary from organization to organization.

### SUMMARY OF THE INVENTION

Evaluating service oriented architecture (‘SOA’) governance maturity including receiving, from a plurality of predetermined stakeholders in the SOA for a plurality of SOA governance capabilities, a stakeholder assessed value representing the current maturity of each of the plurality of SOA governance capabilities; determining, for each of the plurality of SOA governance capabilities in dependence upon the plurality of stakeholder assessed values from the stakeholders, a capability value for each of the plurality of SOA governance capabilities; assigning each of the SOA governance capabilities to a domain; determining, in dependence upon the capability values for each of the plurality of SOA governance capabilities of each domain, a domain maturity value for each domain; and communicating the domain maturity value for each domain to the predetermined stakeholders of the SOA.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of a system for evaluating service oriented architecture (‘SOA’) governance maturity according to embodiments of the present invention.

FIG. 2 sets forth a flow chart illustrating an exemplary method for evaluating service oriented architecture (‘SOA’) governance maturity according to embodiments of the present invention.

FIG. 3 sets forth a flow chart illustrating additional steps used in some additional embodiments of evaluating service oriented architecture (‘SOA’) governance maturity according to the present invention.

FIG. 4 sets forth a block diagram of automated computing machinery comprising an exemplary computer useful in evaluating SOA maturity according to embodiments of the present invention.

### DETAILED DESCRIPTION OF EXEMPLARY EMBODIMENTS

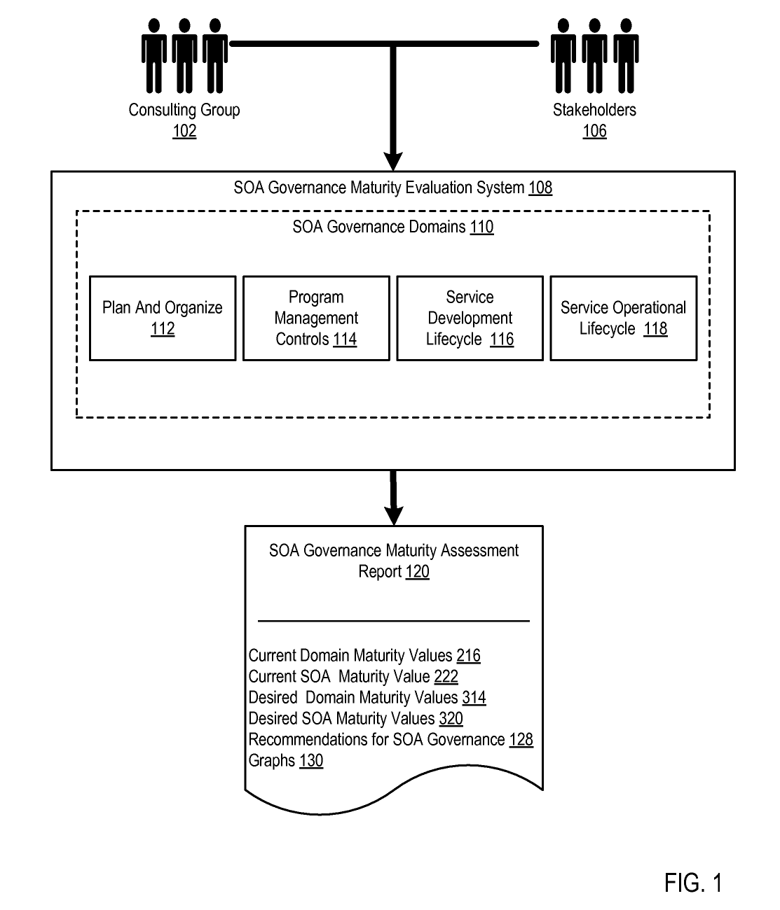

Exemplary methods, systems, and products for evaluating service oriented architecture (‘SOA’) governance maturity in accordance with the present invention are described with reference to the accompanying drawings, beginning with FIG. 1. FIG. 1 sets forth a block diagram of a system for evaluating service oriented architecture (‘SOA’) governance maturity according to embodiments of the present invention. SOA is an architectural style that guides all aspects of creating and using business processes, packaged as services, throughout their lifecycle, as well as defining and provisioning the information technology (‘IT’) infrastructure that allows different applications to exchange data and participate in business processes loosely coupled from the operating systems and programming languages underlying those applications. SOA represents a model in which functionality is decomposed into distinct units, called services, which can be distributed over a network, can be combined together, and reused to create business applications. These services communicate with each other by passing data from one service to another, or by coordinating an activity between two or more services. The concepts of Service Oriented Architecture are often seen as built upon, and the evolution of, the older concepts of distributed computing and modular programming.

SOA governance implements the set of rules, practices, roles, responsibilities and agreements—whether formal or informal—that organize work on the SOA being governed. The maturity of an SOA governance program is an indication of the degree of development, experience, and reliability of the governance of the SOA. As such, a more developed, experienced, and reliable SOA governance program is more mature than a less developed, experienced, and reliable SOA governance program.

The system of FIG. 1 includes an SOA governance maturity system (108) capable of evaluating service oriented architecture (‘SOA’) governance maturity according to embodiments of the present invention. In the example of FIG. 1, the SOA governance maturity system (108) receives, from a plurality of predetermined stakeholders (106) in the SOA for a plurality of SOA governance capabilities, a stakeholder assessed value representing the current maturity of each of the plurality of SOA governance capabilities. A stakeholder (106) of a business may be any individual or party that affects, or can be affected by, a business's SOA actions. The “predetermined stakeholders,” as the term is used in this specification, refers to stakeholders that have been selected to provide information regarding the maturity of the governance of the SOA. Such predetermined stakeholders are typically the stakeholders that are often the most directly affected by the business's actions with respect to SOA and have been given decision making authority with regard to one or more aspects of the SOA governance model.

SOA governance capabilities are the governance practices of granular aspects of the SOA. Such governance capabilities are each an individual portion of the overall SOA governance and individually implement the rules, practices, roles, responsibilities, and agreements with respect to specific part the governance of the SOA. Examples of specific SOA governance capabilities include:
Service Transformation Planning—Capability to identify and plan for the set of services, especially business services, that support the to-be agile business process.
Information Transformation Planning—Capability to create a reusable message model and to identify the set of information services that supports the business model.
Technology Transformation Planning—Capability to create and maintain a technology plan for standards and policies for hardware, software, development lifecycle, and services reference architectures in order to have a cost effective approach to the creation of services and business & IT agility.
Service Processes, Organizations, Roles and Responsibilities—Capability to guide the processes used for SOA Governance, including the organizations that are enhanced or created and the manner in which they interact with each other, as well as the roles and responsibilities of the personnel participating.
Manage the Service Investment—Capability to manage the investment of money to create services and business agility including creating a business case for the SOA, the business metrics to be monitored and used to rate the results of projects after completion, and input into the investment of future funding.
Business Vision & IT Alignment—Capability to create the business goals and be able to align IT in the support of those goals.
Service Portfolio Management—Capability to manage the process for selection of projects to be selected that demonstrates the ability to direct investment resources based on reuse capability and agile business service creation.
Service Ownership & Funding—Capability to identify and control who funds what services, who owns what services and how rights and obligations are distributed.
Service Governance Vitality—Capability to inspect and measure results of the SOA program, including SOA Governance and take corrective action as needed.
Service Communication Planning—Capability to plan and execute the communications of both the business and technical aspects of a services approach to all stakeholders. This includes the ability of the business to understand and lead the application of business processes, business services, business rules, and business metrics to create an agile enterprise.
Service Education & Training Capability to educate and train stakeholders on the SOA approach
Enterprise Program Management—Capability to effectively provide Program Management to ensure the delivery of SOA project results within agreed-upon time frames, budget and quality.
Change Management—Capabiltity to manage the process of program change in responding to changing business requirements.
Procurement of Resources—Capability to manage the process of procuring IT resources in a cost efficient manner while meeting business requirements
Vendor Management—Capability to manage third-party vendors providing SOA services or resources
Identify and Allocate Costs—Capability to identify and allocate costs of a services approach.
Monitor Business Benefits of SOA—Capability to monitor and provide a feedback loop on the business benefits of SOA
Service Development Lifecycle Controls—Capability to govern the SvDLC with Control Gates or similar mechanisms
Requirements Gathering & Prioritization—Capability to govern the creation of Business Requirements that support a flexible business
Service Identification—Capability to govern the Service Identification process to support the identifying of business services and operations at the right level of granularity
Service Specification—Capability to govern the Service Specification process to support the specification of business services and operations in a manner such that the services are readily built and deployed.
Service Realization—Capability to govern the Service Realization process to support the creation, maintenance, and testing of services.
Service Certification—Capability to govern the Service Certification process to support the certification of business services and operations in a manner such that the services are operationally ready for production.
Service Execution Monitoring—Capability to monitor and report results of required service level agreements (SLA's) for external services and operational level agreements (OLA's) for internal services, including identifying when there is acceptable and unacceptable service operations.
Service Operational Vitality—Capability to manage the operational vitality of quality of services. This includes service latency, service elapsed time, hardware and software quality in support for services, priority of services support, service versioning, and prioritized allocation of customer service support.
Service Support—Capability to manage the analysis and resolution of incidents affecting services quality.

The SOA governance capabilities listed above are provided for explanation and not for limitation. In fact, many additional SOA governance capabilities may occur to those of skill in the art and all such SOA governance capabilities may be useful in carrying out evaluating SOA governance maturity according to embodiments of the present invention.

A stakeholder assessed value representing the current maturity of each of the plurality of SOA governance capabilities according to the present invention is a value provided by each of the predetermined stakeholders representing the current maturity of that SOA governance capability. Such a stakeholder assessed value may be provided as a numerical value representing the maturity of the SOA governance capability in response to a questionnaire provided by a consulting group (102). In the example of FIG. 1 a questionnaire is provided by a consulting group (102) to the predetermined stakeholders (106) asking the stakeholders to provide a numerical value representing the current maturity of a plurality of SOA governance capabilities.

The use of numerical values in this specification is for explanation and not for limitation. In fact, evaluating SOA governance maturity according to embodiments of the present invention may usefully use values that are not numerical but implemented in other ways such as symbolic, alphabetical, alphanumeric, or any other manner of implementing a value that will occur to those of skill in the art.

The SOA governance maturity evaluation system of FIG. 1 is also capable of receiving, from the plurality of predetermined stakeholders (106) in the SOA for a plurality of SOA governance capabilities, a desired stakeholder maturity value representing a desired maturity of each of the plurality of SOA governance capabilities. A desired stakeholder maturity value according to the present invention is a value provided by each of the predetermined stakeholders representing a desired future maturity of that SOA governance capability. Such a desired stakeholder maturity value may be provided as a numerical value representing the desired maturity of the SOA governance capability in response to a questionnaire provided by a consulting group (102).

The SOA governance maturity evaluation system of FIG. 1 is capable of determining, for each of the plurality of SOA governance capabilities in dependence upon the plurality of stakeholder assessed values from the stakeholders, a capability value for each of the plurality of SOA governance capabilities. A capability value is a single value representing the maturity of the SOA governance capability. Such a value may be determined by averaging the stakeholder assessed values, using a weighted average of the stakeholder assessed values, using a predetermined formula other than an average, taking the median average, or any other way of determining a single value representing the maturity of the SOA capability from the stakeholder assessed capabilities that will occur to those of skill in the art.

The SOA governance maturity evaluation system of FIG. 1 is capable of determining, for each of the SOA governance capabilities in dependence upon the plurality of desired stakeholder maturity values, a desired capability value for each of the SOA governance capabilities. A desired capability value is a single value representing the desired future maturity of the SOA governance capability. Such a value may be determined by averaging the desired stakeholder maturity values, using a weighted average of the desired stakeholder maturity values, using a predetermined formula other than an average, taking the median average, or any other way of determining a single value representing the desired maturity of the SOA capability from the desired stakeholder maturity values that will occur to those of skill in the art.

The SOA governance maturity evaluation system of FIG. 1 is capable of assigning each of the SOA governance capabilities to a domain (110). A domain of SOA governance is a broader description of related SOA governance capabilities. Examples of such domains include:
Plan and Organize (112)—This domain is concerned with the governance of the strategy for SOA. It focuses on the planning and organization for an SOA-enabled transformation at all levels of an SOA Solution Stack including governance vitality, communications and training. These are not ‘day to day’ activities, but are strategic in nature and set the direction for the SOA and SOA Governance program as a whole. While not ‘day to day’, the decisions taken here will undergo review and change as the needs of the business change or as the enterprise continues to mature in its SOA journey.
Program Management Controls (114)—This domain focuses on uplifting the capability of the program management area in making the transition from a department or Line of Business project management capability to a true enterprise wide program management set of capabilities. It focuses specifically on how the program and individual projects manage SOA-related risks, including change management, procurement management, vendor management, and cost and benefits.
Service Development Lifecycle (116)—This Domain is focused on the standardization of the Service Development Lifecycle and the formalization of the governance controls needed in order to ensure service development quality of service.
Service Operational Lifecycle (118)—This area is focused on the standardization of the Service Operations Lifecycle and the formalization of the governance controls needed in order to ensure service operations quality of service.

The domains listed above are provided for explanation and not for limitation. In fact, many additional domains may occur to those of skill in the art and all such domains may be useful in carrying out evaluating SOA governance maturity according to embodiments of the present invention.

Assigning each of the exemplary SOA governance capabilities identified above to an exemplary domain identified above may result in the following domains associated with the following governance capabilities:
Plan and Organize (112)—Service Transformation Planning; Information Transformation Planning; Technology Transformation Planning; Service Processes, Organizations, Roles and Responsibilities; Manage the Service Investment; Business Vision & IT Alignment; Service Portfolio Management; Service Ownership & Funding; Service Governance Vitality; Service Communication Planning; and Service Education & Training
Program Management Controls (114)—Enterprise Program Management; Change Management; Procurement of Resources; Vendor Management; Identify and Allocate Costs; and Monitor Business Benefits of SOA
Service Development Lifecycle (116)—Service Development Lifecycle Controls; Requirements Gathering & Prioritization; Service Identification; Service Specification; Service Realization; and Service Certification
Service Operational Lifecycle (118)—Service Execution Monitoring; Service Operational Vitality; and Service Support

The SOA governance capabilities assigned to domains listed above are provided for explanation and not for limitation. In fact, many additional or different SOA governance capabilities may be assigned to additional or different domains may occur to those of skill in the art and all such assignments may be useful in carrying out evaluating SOA governance maturity according to embodiments of the present invention.

The SOA governance maturity evaluation system (108) of FIG. 1 is also capable of determining, in dependence upon the capability values for each of the plurality of SOA governance capabilities of each domain, a domain maturity value (216) for each domain. A domain maturity value is a single value representing the maturity of the governance of the domain. Such a value may be determined by averaging the capability values for each domain, using a weighted average of the capability values, using a predetermined formula other than an average of the capability values, taking the median average of the capability values, or any other way of determining a single value representing the maturity of the domain from the capability values that will occur to those of skill in the art.

The SOA governance maturity evaluation system (108) of FIG. 1 is also capable of determining, in dependence upon the desired capability values for each of the SOA governance capabilities, a desired domain maturity value for each domain. A desired domain maturity value is a single value representing the desired future maturity of the governance of the domain. Such a value may be determined by averaging the desired capability values for each domain, using a weighted average of the desired capability values, using a predetermined formula other than an average of the desired capability values, taking the median average of the desired capability values, or any other way of determining a single value representing the desired future maturity of the domain from the desired capability values that will occur to those of skill in the art.

The SOA governance maturity evaluation system (108) of FIG. 1 is also capable of determining, in dependence upon the domain maturity values for each domain (112, 114, 116, 118) an SOA governance maturity value (222). An SOA governance maturity value is a single value representing the maturity of the SOA governance. Such a value may be determined by averaging the domain maturity values, using a weighted average of the domain maturity values, using a predetermined formula other than an average of the domain maturity values, taking the median average of the domain maturity values, or any other way of determining a single value representing the maturity of the governance of the SOA from the domain maturity that will occur to those of skill in the art.

The SOA governance maturity evaluation system (108) of FIG. 1 is also capable of determining, in dependence upon the desired domain maturity values for each domain, a desired SOA governance maturity value A desired SOA governance maturity value is a single value representing the desired future maturity of the SOA governance. Such a value may be determined by averaging the desired domain maturity values, using a weighted average of the desired domain maturity values, using a predetermined formula other than an average of the desired domain maturity values, taking the median average of the desired domain maturity values, or any other way of determining a single value representing the desired maturity of the governance of the SOA from the desired domain maturity that will occur to those of skill in the art.

The SOA governance maturity evaluation system (108) of FIG. 1 is also capable of communicating the domain maturity value (216), the SOA maturity value (222), the desired domain maturity value (314), and the desired SOA maturity value (320) to the predetermined stakeholders (106) of the SOA. In the example of FIG. 1 the SOA governance maturity evaluation system (108) is capable of creating a report (120) that includes the domain maturity value (216), the SOA maturity value (222), the desired domain maturity value (314), and the desired SOA maturity value (320) and describing recommendations (128) for the SOA in dependence upon domain maturity value (216), the SOA maturity value (222), the desired domain maturity value (314), and the desired SOA maturity value (320) to the predetermined stakeholders (106) of the SOA. Such recommendations may be retrieved automatically from a database in dependence upon domain the maturity value (216), the SOA maturity value (222), the desired domain maturity value (314), and the desired SOA maturity value (320) to the predetermined stakeholders (106) of the SOA for later edit by a user or created dynamically in dependence upon domain maturity value (216), the SOA maturity value (222), the desired domain maturity value (314), and the desired SOA maturity value (320) to the predetermined stakeholders (106) of the SOA as will occur to those of skill in the art. In the example of FIG. 1 the report (120) may be created automatically using a template for the report. In the example of FIG. 1 the report also includes graphs (130) provided for further explanations of the domain maturity value (216), the SOA maturity value (222), the desired domain maturity value (314), and the desired SOA maturity value (320) to the predetermined stakeholders (106) of the SOA and the resulting recommendations (128).

Data processing systems useful in evaluating service oriented architecture (‘SOA’) governance maturity according to various embodiments of the present invention may include computers, servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

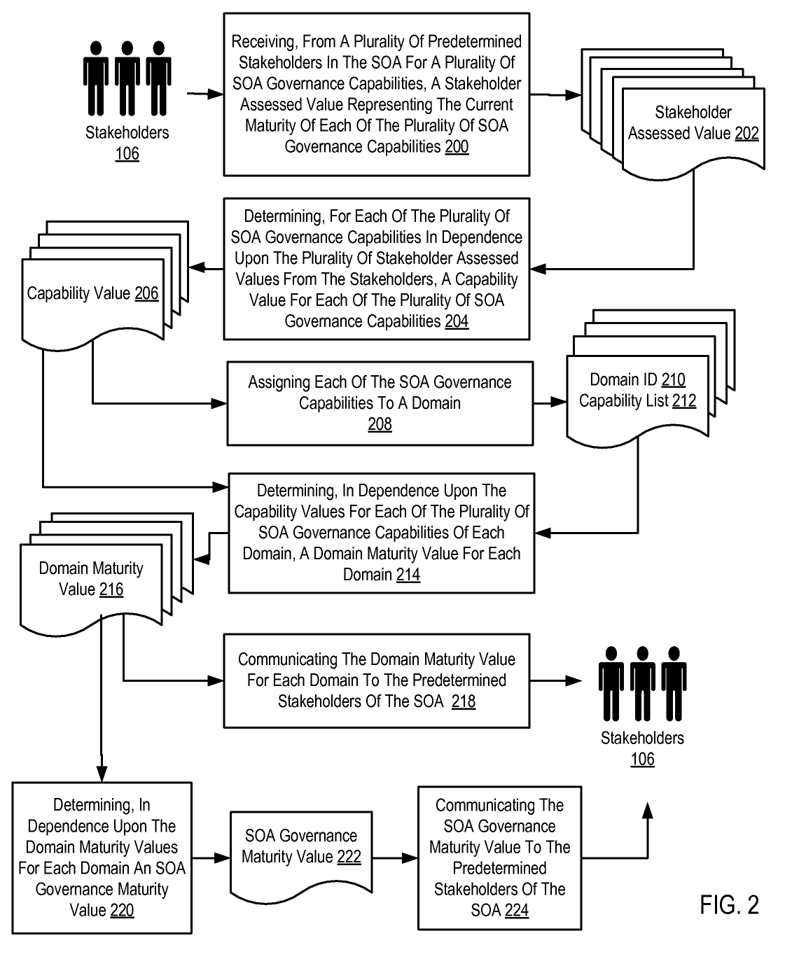

For further explanation, FIG. 2 sets forth a flow chart illustrating an exemplary method for evaluating service oriented architecture (‘SOA’) governance maturity according to embodiments of the present invention. The method of FIG. 2 includes receiving (200), from a plurality of predetermined stakeholders (106) in the SOA for a plurality of SOA governance capabilities, a stakeholder assessed value (202) representing the current maturity of each of the plurality of SOA governance capabilities. As mentioned above, a predetermined stakeholder (106) refers to stakeholders that have been selected to provide information regarding the maturity of the governance of the SOA and SOA governance capabilities are the governance practices of granular aspects of the SOA, and a stakeholder assessed value representing the current maturity of each of the plurality of SOA governance capabilities according to the present invention is a value provided by each of the predetermined stakeholders representing the current maturity of that SOA governance capability.

The method of FIG. 2 includes determining (204), for each of the plurality of SOA governance capabilities in dependence upon the plurality of stakeholder assessed values (202) from the stakeholders (106), a capability value (206) for each of the plurality of SOA governance capabilities. As mentioned above, a capability value is a single value representing the maturity of the SOA governance capability. Determining (204), for each of the plurality of SOA governance capabilities in dependence upon the plurality of stakeholder assessed values (202) from the stakeholders, a capability value (206) for each of the plurality of SOA governance capabilities may be carried out by averaging the stakeholder assessed values, using a weighted average of the stakeholder assessed values, using a predetermined formula other than an average, taking the median average, or any other way of determining a single value representing the maturity of the SOA capability from the stakeholder assessed capabilities that will occur to those of skill in the art.

The method of FIG. 2 also includes assigning (208) each of the SOA governance capabilities to a domain. In the example of FIG. 2 a domain ID (210) identifying a particular domain has assigned to it one or more capabilities included in a capability list (212). As mentioned above, domain of SOA governance is a broader description of related SOA governance capabilities.

The method of FIG. 2 includes determining (214), in dependence upon the capability values (206) for each of the plurality of SOA governance capabilities of each domain, a domain maturity value (216) for each domain. As mentioned above, a domain maturity value is a single value representing the maturity of the governance of the domain. Determining, in dependence upon the capability values for each of the plurality of SOA governance capabilities of each domain, a domain maturity value (216) for each domain may be carried out by averaging the capability values for each domain, using a weighted average of the capability values, using a predetermined formula other than an average of the capability values, taking the median average of the capability values, or any other way of determining a single value representing the maturity of the domain from the capability values that will occur to those of skill in the art.

The method of FIG. 2 includes communicating (218) the domain maturity value (216) for each domain to the predetermined stakeholders (106) of the SOA. Communicating (218) the domain maturity value for each domain to the predetermined stakeholders of the SOA may be carried out by creating a report describing recommendations for the SOA in dependence upon the domain maturity value and transmitting the report to the predetermined stakeholders.

The method of FIG. 2 also includes determining (220), in dependence upon the domain maturity values (216) for each domain an SOA governance maturity value (222). As mentioned above, an SOA governance maturity value is a single value representing the maturity of the SOA governance. Determining (220), in dependence upon the domain maturity values (216) for each domain an SOA governance maturity value (222) may be carried out by averaging the domain maturity values, using a weighted average of the domain maturity values, using a predetermined formula other than an average of the domain maturity values, taking the median average of the domain maturity values, or any other way of determining a single value representing the maturity of the governance of the SOA from the domain maturity that will occur to those of skill in the art.

The method of FIG. 2 also includes communicating (224) the SOA governance maturity value to the predetermined stakeholders (106) of the SOA. Communicating (224) the SOA governance maturity value (222) to the predetermined stakeholders (106) of the SOA may be carried out by creating a report describing recommendations for SOA governance in dependence upon the SOA governance maturity value (222) and transmitting the report to the predetermined stakeholders (106).

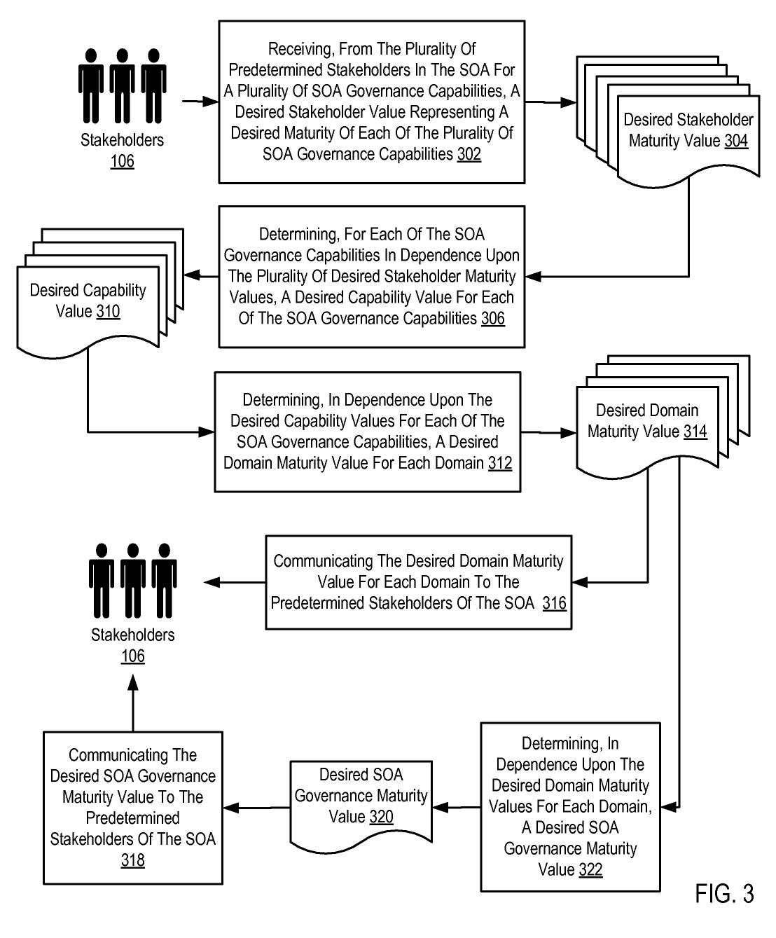

As mentioned above, stakeholders may provide values representing desired maturity of SOA capabilities for use in some embodiments of evaluating SOA maturity that determines desired capability values, desired domain maturity values and desired SOA maturity values. For further explanation, FIG. 3 sets forth a flow chart illustrating additional steps used in some additional embodiments of evaluating service oriented architecture (‘SOA’) governance maturity according to the present invention. The method of FIG. 3 includes receiving (302), from the plurality of predetermined stakeholders (106) in the SOA for a plurality of SOA governance capabilities, a desired stakeholder maturity value (304) representing a desired maturity of each of the plurality of SOA governance capabilities. A desired capability value is a single value representing the desired future maturity of the SOA governance capability.

The method of FIG. 3 also includes determining (306), for each of the SOA governance capabilities in dependence upon the plurality of desired stakeholder maturity values (304), a desired capability value (310) for each of the SOA governance capabilities. A desired capability value is a single value representing the desired future maturity of the SOA governance capability. Determining (306), for each of the SOA governance capabilities in dependence upon the plurality of desired stakeholder maturity values (304), a desired capability value (310) for each of the SOA governance capabilities may be carried out by averaging the desired stakeholder maturity values, using a weighted average of the desired stakeholder maturity values, using a predetermined formula other than an average, taking the median average, or any other way of determining a single value representing the desired maturity of the SOA capability from the desired stakeholder maturity values that will occur to those of skill in the art.

The method of FIG. 3 also includes determining (312), in dependence upon the desired capability values (310) for each of the SOA governance capabilities, a desired domain maturity value (314) for each domain. A desired domain maturity value is a single value representing the desired future maturity of the governance of the domain. Determining (312), in dependence upon the desired capability values (310) for each of the SOA governance capabilities, a desired domain maturity value (314) for each domain may be carried out by averaging the desired capability values for each domain, using a weighted average of the desired capability values, using a predetermined formula other than an average of the desired capability values, taking the median average of the desired capability values, or any other way of determining a single value representing the desired future maturity of the domain from the desired capability values that will occur to those of skill in the art.

The method of FIG. 3 also includes communicating (316) the desired domain maturity value (314) for each domain to the predetermined stakeholders (106) of the SOA. Communicating (316) the desired domain maturity value (314) for each domain to the predetermined stakeholders of the SOA may be carried out by creating a report describing recommendations for SOA governance in dependence upon the current maturity of each domain of the SOA and describing recommendations for SOA governance in dependence upon the desired maturity value (314) of each domain and transmitting the report to the predetermined stakeholders (106).

The method of FIG. 3 also includes determining (322) , in dependence upon the desired domain maturity values (314) for each domain, a desired SOA governance maturity value (318) and communicating the desired SOA governance maturity value (320) to the predetermined stakeholders of the SOA. A desired SOA governance maturity value is a single value representing the desired future maturity of the SOA governance. Determining (322), in dependence upon the desired domain maturity values (314) for each domain, a desired SOA governance maturity value (318) may be carried out by averaging the desired domain maturity values, using a weighted average of the desired domain maturity values, using a predetermined formula other than an average of the desired domain maturity values, taking the median average of the desired domain maturity values, or any other way of determining a single value representing the desired maturity of the governance of the SOA from the desired domain maturity that will occur to those of skill in the art. Communicating the desired SOA governance maturity value (322) to the predetermined stakeholders of the SOA further comprises creating a report describing recommendations for SOA governance in dependence upon the current SOA maturity value and describing recommendations for SOA governance in dependence upon the desired SOA maturity value and transmitting the report to the predetermined stakeholders.

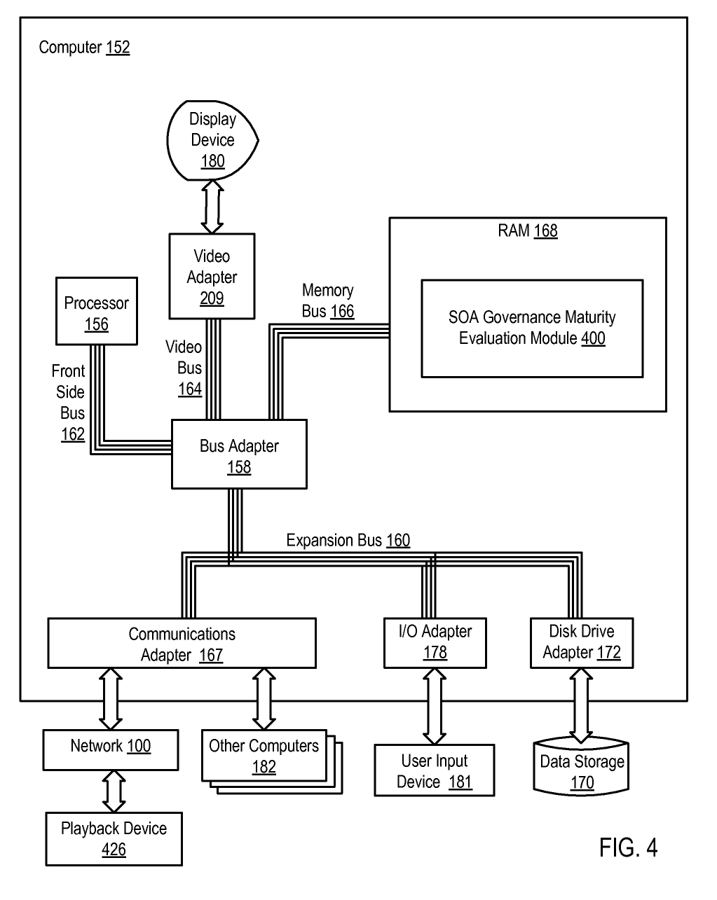

Evaluating SOA governance maturity in accordance with the present invention is generally implemented with computers, that is, with automated computing machinery. For further explanation, therefore, FIG. 4 sets forth a block diagram of automated computing machinery comprising an exemplary computer (152) useful in evaluating SOA maturity according to embodiments of the present invention. The computer (152) of FIG. 4 includes at least one computer processor (156) or ‘CPU’ as well as random access memory (168) (‘RAM’) which is connected through a high speed memory bus (166) and bus adapter (158) to processor (156) and to other components of the computer (152).

Stored in RAM (168) is a SOA governance maturity evaluation module (400), a module of computer program instructions for evaluating SOA governance maturity. The SOA governance maturity evaluation module (400) is capable of receiving, from a plurality of predetermined stakeholders in the SOA for a plurality of SOA governance capabilities, a stakeholder assessed value representing the current maturity of each of the plurality of SOA governance capabilities; determining, for each of the plurality of SOA governance capabilities in dependence upon the plurality of stakeholder assessed values from the stakeholders, a capability value for each of the plurality of SOA governance capabilities; assigning each of the SOA governance capabilities to a domain; determining, in dependence upon the capability values for each of the plurality of SOA governance capabilities of each domain, a domain maturity value for each domain; and communicating the domain maturity value for each domain to the predetermined stakeholders of the SOA by creating a report describing recommendations for the SOA in dependence upon the domain maturity value and transmitting the report to the predetermined stakeholders.

The SOA governance maturity evaluation module (400) is also capable of determining, in dependence upon the domain maturity values for each domain an SOA governance maturity value and communicating the SOA governance maturity value to the predetermined stakeholders of the SOA by creating a report describing recommendations for SOA governance in dependence upon the current SOA maturity and transmitting the report to the predetermined stakeholders.

The SOA governance maturity evaluation module (400) of FIG. 4 is also capable of receiving, from the plurality of predetermined stakeholders in the SOA for a plurality of SOA governance capabilities, a desired stakeholder maturity value representing a desired maturity of each of the plurality of SOA governance capabilities; determining, for each of the SOA governance capabilities in dependence upon the plurality of desired stakeholder maturity values, a desired capability value for each of the SOA governance capabilities; determining, in dependence upon the desired capability values for each of the SOA governance capabilities, a desired domain maturity value for each domain; and communicating the desired domain maturity value for each domain to the predetermined stakeholders of the SOA by creating a report describing the recommendations for SOA governance in dependence upon the current maturity of each domain of the SOA and describing recommendations for SOA governance in dependence upon the desired maturity of each domain and transmitting the report to the predetermined stakeholders.

The SOA governance maturity evaluation module (400) of FIG. 4 is capable of determining, in dependence upon the desired domain maturity values for each domain, a desired SOA governance maturity value and communicating the desired SOA governance maturity value to the predetermined stakeholders of the SOA by creating a report describing recommendations for SOA governance in dependence upon the current SOA maturity and describing recommendations for SOA governance in dependence upon the desired SOA maturity and transmitting the report to the predetermined stakeholders.

Also stored in RAM (168) is an operating system (154). An operating system is a computer software component that is responsible for execution of applications programs and for administration of access to computer resources, memory, processor time, and I/O functions, on behalf of application programs. Operating systems useful evaluating SOA governance maturity according to embodiments of the present invention include UNIX™, Linux™, Microsoft XP™, AIX™, IBM's i5/OS™, and others as will occur to those of skill in the art. The operating system (154) and the SOA governance maturity evaluation module (400) in the example of FIG. 4 are shown in RAM (168), but many components of such software typically are stored in non-volatile memory also, such as, for example, on a disk drive (170).

The computer (152) of FIG. 4 includes disk drive adapter (172) coupled through expansion bus (160) and bus adapter (158) to processor (156) and other components of the computer (152). Disk drive adapter (172) connects non-volatile data storage to the computer (152) in the form of disk drive (170). Disk drive adapters useful in computers for evaluating SOA governance maturity according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example computer (152) of FIG. 4 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. The example computer (152) of FIG. 4 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary computer (152) of FIG. 4 includes a communications adapter (167) for data communications with other computers (182) and for data communications with a data communications network (100). Such data communications may be carried out serially through RS-232 connections, through external buses such as a Universal Serial Bus (‘USB’), through data communications data communications networks such as IP data communications networks, and in other ways as will occur to those of skill in the art. Communications adapters implement the hardware level of data communications through which one computer sends data communications to another computer, directly or through a data communications network. Examples of communications adapters useful for evaluating SOA governance maturity according to embodiments of the present invention include modems for wired dial-up communications, Ethernet (IEEE 802.3) adapters for wired data communications network communications, and 802.11 adapters for wireless data communications network communications.

Exemplary embodiments of the present invention are described largely in the context of a fully functional system for evaluating service oriented architecture (‘SOA’) governance maturity. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of evaluating service oriented architecture (‘SOA’) governance maturity, the method comprising:
receiving, from a plurality of predetermined stakeholders in the SOA for a plurality of SOA governance capabilities, a stakeholder assessed value representing the current maturity of each of the plurality of SOA governance capabilities;
determining, for each of the plurality of SOA governance capabilities in dependence upon the plurality of stakeholder assessed values from the stakeholders, a capability value for each of the plurality of SOA governance capabilities;
assigning each of the SOA governance capabilities to a domain;
determining, in dependence upon the capability values for each of the plurality of SOA governance capabilities of each domain, a domain maturity value for each domain; and
communicating the domain maturity value for each domain to the predetermined stakeholders of the SOA.

2. The method of claim 1 further comprising determining, in dependence upon the domain maturity values for each domain an SOA governance maturity value and communicating the SOA governance maturity value to the predetermined stakeholders of the SOA.

3. The method of claim 2 wherein communicating the SOA governance maturity value to the predetermined stakeholders of the SOA further comprises creating a report describing recommendations for SOA governance in dependence upon the SOA governance maturity value and transmitting the report to the predetermined stakeholders.

4. The method of claim 1 further comprising:
receiving, from the plurality of predetermined stakeholders in the SOA for a plurality of SOA governance capabilities, a desired stakeholder maturity value representing a desired maturity of each of the plurality of SOA governance capabilities;
determining, for each of the SOA governance capabilities in dependence upon the plurality of desired stakeholder maturity values, a desired capability value for each of the SOA governance capabilities,
determining, in dependence upon the desired capability values for each of the SOA governance capabilities, a desired domain maturity value for each domain; and
communicating the desired domain maturity value for each domain to the predetermined stakeholders of the SOA.

5. The method of claim 4 wherein communicating the desired domain maturity value for each domain to the predetermined stakeholders of the SOA further comprises creating a report describing the recommendations for SOA governance in dependence upon the current maturity of each domain of the SOA and describing recommendations for SOA governance in dependence upon the desired maturity of each domain and transmitting the report to the predetermined stakeholders.

6. The method of claim 4 further comprising determining, in dependence upon the desired domain maturity values for each domain, a desired SOA governance maturity value and communicating the desired SOA governance maturity value to the predetermined stakeholders of the SOA.

7. The method of claim 6 wherein communicating the desired SOA governance maturity value to the predetermined stakeholders of the SOA further comprises creating a report describing recommendations for SOA governance in dependence upon the current SOA maturity and describing recommendations for SOA governance in dependence upon the desired SOA maturity and transmitting the report to the predetermined stakeholders.

8. The method of claim 1 wherein communicating the domain maturity value for each domain to the predetermined stakeholders of the SOA further comprises creating a report describing recommendations for the SOA in dependence upon the domain maturity value and transmitting the report to the predetermined stakeholders.

9. A system for evaluating service oriented architecture (‘SOA’) governance maturity, the system comprising a computer processor, a computer memory operatively coupled to the computer processor, the computer memory having disposed within it computer program instructions capable of:
receiving, from a plurality of predetermined stakeholders in the SOA for a plurality of SOA governance capabilities, a stakeholder assessed value representing the current maturity of each of the plurality of SOA governance capabilities;
determining, for each of the plurality of SOA governance capabilities in dependence upon the plurality of stakeholder assessed values from the stakeholders, a capability value for each of the plurality of SOA governance capabilities;
assigning each of the SOA governance capabilities to a domain;
determining, in dependence upon the capability values for each of the plurality of SOA governance capabilities of each domain, a domain maturity value for each domain; and
communicating the domain maturity value for each domain to the predetermined stakeholders of the SOA.

10. The system of claim 9 wherein the computer memory also has disposed within it computer program instructions capable of determining, in dependence upon the domain maturity values for each domain an SOA governance maturity value and communicating the SOA governance maturity value to the predetermined stakeholders of the SOA.

11. The system of claim 9 wherein the computer memory also has disposed within it computer program instructions capable of:
receiving, from the plurality of predetermined stakeholders in the SOA for a plurality of SOA governance capabilities, a desired stakeholder maturity value representing a desired maturity of each of the plurality of SOA governance capabilities;
determining, for each of the SOA governance capabilities in dependence upon the plurality of desired stakeholder maturity values, a desired capability value for each of the SOA governance capabilities,
determining, in dependence upon the desired capability values for each of the SOA governance capabilities, a desired domain maturity value for each domain; and
communicating the desired domain maturity value for each domain to the predetermined stakeholders of the SOA.

12. The system of claim 11 wherein the computer memory also has disposed within it computer program instructions capable of determining, in dependence upon the desired domain maturity values for each domain, a desired SOA governance maturity value and communicating the desired SOA governance maturity value to the predetermined stakeholders of the SOA.

13. The system of claim 9 wherein communicating the domain maturity value for each domain to the predetermined stakeholders of the SOA further comprises creating a report describing recommendations for the SOA in dependence upon the domain maturity value and transmitting the report to the predetermined stakeholders.

14. A computer program product of evaluating service oriented architecture (‘SOA’) governance maturity, the computer program product disposed in a signal bearing medium, the computer program product comprising computer program instructions capable of:
receiving, from a plurality of predetermined stakeholders in the SOA for a plurality of SOA governance capabilities, a stakeholder assessed value representing the current maturity of each of the plurality of SOA governance capabilities;
determining, for each of the plurality of SOA governance capabilities in dependence upon the plurality of stakeholder assessed values from the stakeholders, a capability value for each of the plurality of SOA governance capabilities;
assigning each of the SOA governance capabilities to a domain;
determining, in dependence upon the capability values for each of the plurality of SOA governance capabilities of each domain, a domain maturity value for each domain; and
communicating the domain maturity value for each domain to the predetermined stakeholders of the SOA.

15. The computer program product of claim 14 further comprising computer program instructions capable of determining, in dependence upon the domain maturity values for each domain an SOA governance maturity value and communicating the SOA governance maturity value to the predetermined stakeholders of the SOA.

16. The computer program product of claim 15 wherein computer program instructions capable of comprising communicating the SOA governance maturity value to the predetermined stakeholders of the SOA further comprise computer program instructions capable of creating a report describing recommendations for SOA governance in dependence upon the SOA governance maturity value and transmitting the report to the predetermined stakeholders.

17. The computer program product of claim 14 further comprising computer program instructions capable of:
receiving, from the plurality of predetermined stakeholders in the SOA for a plurality of SOA governance capabilities, a desired stakeholder maturity value representing a desired maturity of each of the plurality of SOA governance capabilities;
determining, for each of the SOA governance capabilities in dependence upon the plurality of desired stakeholder maturity values, a desired capability value for each of the SOA governance capabilities,
determining, in dependence upon the desired capability values for each of the SOA governance capabilities, a desired domain maturity value for each domain; and
communicating the desired domain maturity value for each domain to the predetermined stakeholders of the SOA.

18. The computer program product of claim 14 wherein computer program instructions capable of communicating the desired domain maturity value for each domain to the predetermined stakeholders of the SOA further comprise computer program instructions capable of creating a report describing the recommendations for SOA governance in dependence upon the current maturity of each domain of the SOA and describing recommendations for SOA governance in dependence upon the desired maturity of each domain and transmitting the report to the predetermined stakeholders.

19. The computer program product of claim 14 further comprising computer program instructions capable of determining, in dependence upon the desired domain maturity values for each domain, a desired SOA governance maturity value and communicating the desired SOA governance maturity value to the predetermined stakeholders of the SOA.

20. The computer program product of claim 1 wherein computer program instructions capable of communicating the domain maturity value for each domain to the predetermined stakeholders of the SOA further comprise computer program instructions capable of creating a report describing recommendations for the SOA in dependence upon the domain maturity value and transmitting the report to the predetermined stakeholders.
